(19) United States
(12) Patent Application Publication
(10) Pub. No.: US 2003/0076743 A1
(43) Pub. Date: Apr. 24, 2003

(54) Enhancement of acoustic wave sensor response by electrode modification

(76) Inventors: Michael Thompson, Toronto (CA); Shakour Ghafouri, Toronto (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/247,707

(22) Filed: Sep. 20, 2002

(30) Foreign Application Priority Data
Sep. 20, 2001 (CA) 2,357,522

(51) Int. Cl. H04R 1/00

(52) U.S. Cl. 367/140

(57) ABSTRACT

Geometry, polarity of the exciting electrodes, and stray capacitance effect the performance of the thickness-shear mode acoustic wave sensor operating in electrolytes and solutions of biomolecules. In contrast to the mass-based response of the device operating in the gas phase, the response in a liquid is governed by factors including acoustoelectric, and fringing field effects, which are known to be active at the edges of the electrodes. The invention relates to an electrode having modified geometry to increase the edge length to raise the sensitivity of the device, and to enhance the sensor response.

This application claims the benefit of priority from Canadian Patent Application Serial Number 2,357,522, filed on Sep. 20, 2001, the entirety of which is herein incorporated by reference.

### BACKGROUND

Thickness-shear-mode (TSM) acoustic wave devices continue to gain attention as a category of highly sensitive sensors for the detection of interfacial chemistry. Several models have been proposed to account for the frequency response of the device in terms of the properties of a surrounding medium. With respect to operation in the gas phase, the successful and well-established model which gives the frequency change as the amount of mass added to the surface of the device's crystal has been proposed. For operation in the liquid phase, a realistic model has been proposed which relates frequency changes to the viscosity and the density of a bulk non-conducting liquid in contact with the sensor surface. Other theories have included the behavior of the device in an electrical equivalent circuit, and the roles-played by an added film and the nature of the solid-liquid interface. Despite this gradual progress in theoretical considerations, the effect of an electrolyte matrix, on a rigorous level, has not generally been included, although some researchers have proposed a semi-quantitative model that predicts frequency changes as a function of the conductivity and dielectric constant of the bulk liquid.

The TSM acoustic wave sensor, also known as a Quartz Crystal Microbalance (QCM), is known for its mass sensitivity when operating in the gas phase. It is gaining increasing attention for potential applications in liquid phase, especially as a biosensor. Methods have been published which incorporate TSM to monitor bulk liquid properties such as viscosity, and attempts have been made to detect chemical/biological analytes by immobilizing suitable probes on the biosensor surface. Progress on such sensors has been, to some degree, obscured because of the small magnitude of the acoustic alterations at the interface brought about by most chemical events.

Important aspect of the use of the TSM in general, and in particular as a biosensor, is obviously the fact that the device is invariably immersed in electrolyte solutions. In order to explain the effects of charged moieties, a common explanation has been that electrostatic interactions modify the structure of the adsorbed film, thus its viscoelasticity, which in turn affects the resonance frequency of the sensor. There is, however, evidence from the response to simple electrolytes at higher concentrations and from the behavior of immobilized DNA exposed to electrolytes of varying ionic strength, that there is a nonlinear dependency of the resonance frequency on the conductivity of the electrolyte.

Considering the increasing interest in the employment of TSM devices as biosensors, and taking into account the fact that most biological samples contain either charged species or exist in buffer and/or saline solutions, a detailed investigation of the conductive loading of the TSM device is warranted. In this work we examine several less-addressed, or even ignored issues, of an electrical nature that are important in the operation of TSM devices subjected to a conductive loading. As background to the ensuing discussion it is first necessary to summarize concisely the effects of an electrical nature that are thought to govern the response of the TSM when immersed in electrolyte solutions.

In addition to the mass and viscosity sensitivity of TSM devices, they also respond to events of an electrical nature at the device surface. Electric fields of different source and strength are known to exist around the oscillating device, the most prominent of which are those resulting from the acoustoelectric effect. This effect is explained by uncompensated electric charges created at the device surface as a result of the acoustic motion in the piezoelectric quartz material. The acoustoelectric fields exist only at the edges of the electrodes and interact with the ions and dipoles of the solution at the vicinity of the device surface.

Most biological species are in charged form in buffer solutions and undergo charge/dipole changes during their activities. The interaction of these species with the probes immobilized on the device surface alters the electrical double layer structure and modifies the acoustoelectric fields at the electrode edges. This in turn affects the oscillation frequency and the equivalent circuit parameters of the device, and a sensor response is the result.

TSM Response and Electrical Parameters

Conductivity. In order to employ the TSM as a mass-sensitive device for the determination of heavy metals, other researchers have described the relationship between the change in series resonance frequency (Δƒₛ) and the conductivity of surrounding electrolyte in diverse sensor configurations. Such dependency is usually linear up to a certain concentration of the electrolyte (typically 20-mM). Interestingly, an opposite dependency was found for Δƒₛ on electrolyte concentration when two different circuits of the oscillator-type (LS-TTL, or IC) were employed. Ih has been explained the latter effect in terms of the magnitude of a capacitance in series with the cell, when an oscillator circuit of the IC-type is employed. The latter group found that the slope of Δƒₛ versus conductivity plots changed from positive to zero to negative as the magnitude of the series capacitance increased from below then to equal and, finally, to above a critical value. This means that by integrating a capacitance of size around the critical capacitance in the oscillator circuit, Δƒₛ could be made to be independent of the conductivity of the solution, an observation that could prove to be useful in TSM applications. For general-purpose applications, an empirical formula was proposed to describe the dependency of frequency shift on several physical parameters:

Δƒ=c₁d^{½}+c²η^{½}−c³ε−c⁴κ+c₀ (1)

where Δƒ is the frequency change with respect to the basic oscillator frequency in air; factors c₀-c₄ are constants that depend on the specific liquid and experimental conditions and d, η, ε, and κ are density, viscosity, permittivity, and conductivity of the solution, respectively. For a dilute electrolyte solution, κ is the only significant parameter responsible for the deviation of frequency from that of pure water. The frequency behavior of a quartz crystal resonator can be modeled in terms of the physical properties of the crystal and the liquid. Here, the frequency shift with respect to basic resonance frequency ƒ₀ of a crystal by in contact with a liquid of density d_{L} and viscosity η_{L}, is given by:

$$\frac{Δ f}{{f}_{0}} = {( \frac{{f}_{0} {ρ}_{L} {η}_{L}}{π {ρ}_{Q} {\overline{C}}_{66}} )}^{1 / 2} + \frac{δ}{{π}^{2}} \frac{{σ}^{2} + {ω}^{2} {ϵ}_{L} ( {ϵ}_{L} + {ϵ}_{22} )}{{σ}^{2} + {{ω}^{2} ( {ϵ}_{L} + {ϵ}_{22} )}^{2}} \qquad ( 2 )$$

where, subscript L denotes the liquid, ω is the angular frequency of the acoustic wave, ρ_{Q}, C₆₆, and ε₂₂ are the density, stiffened elasticity, permittivity, respectively; and δ is the electromechanical coupling constant of quartz which is

$$δ = \frac{{e}_{26}^{2}}{{\overline{C}}_{66} {ϵ}_{22}} \qquad ( 3 )$$

For dilute conductive solutions the above equation becomes:

$$\frac{Δ f}{{f}_{0}} = \frac{δ}{{π}^{2}} \frac{{ϵ}_{22}}{( {ϵ}_{L} + {ϵ}_{22} )} \frac{{σ}^{2}}{{σ}^{2} + {{ω}^{2} ( {ϵ}_{L} + {ϵ}_{22} )}^{2}} \qquad ( 4 )$$

Acoustoelectric Effects. Acoustoelectric phenomena occur in the vicinity of electrode edges because of acoustic motion processes. This movement results in the generation of electric charges at the surface that is not compensated by the metallic electrode. Acoustoelectric charges develop electric fields that penetrate into the adjacent liquid affecting the operation of the TSM device. These charges, in addition to the contribution of the electric fields normal to crystal, cause the formation of a lateral electric field between the unelectroded area and the electrode edge.

In order to enhance and utilize this effect, other researchers have increased the electrode area on the dry side of the crystal and proposed an equivalent circuit model to account for the acoustoelectric effect on modified electrodes. A relationship can be stated for the dependency of the parallel resonance frequency (Δƒₚ) of the modified crystal on viscosity, density, specific conductivity and permittivity of the liquid. For dilute conducting solutions the relative parallel frequency drop with respect to unperturbed parallel frequency in air (Δƒₚ/ƒₚ₀) as compared to that for pure water is:

$${( \frac{Δ {f}_{p}}{{f}_{{p}_{0}}} )}_{s} - {( \frac{Δ {f}_{p}}{{f}_{{p}_{0}}} )}_{w} = \frac{1}{2} ( \frac{8 {K}_{0}^{2}}{{π}^{2}} ) ( \frac{{A}_{1}}{A} ) ( \frac{\frac{{l}_{L}}{d} {ϵ}_{22}}{{ϵ}_{L} + \frac{{l}_{L}}{d} {ϵ}_{22}} ) ( \frac{{σ}^{2}}{{σ}^{2} + {{ω}_{{p}_{0}} ( {ϵ}_{L} + \frac{{l}_{L}}{d} {ϵ}_{22} )}^{2}} ) \qquad ( 5 )$$

where K₀² is the electromechanical coupling constant of quartz, A₁ is the difference of the areas of the two electrodes, A is the total area of the crystal exposed to the liquid, l_{L} is the normal penetration length of the field into the liquid, and d is the thickness of the crystal. The last two terms are related to acoustoelectric coupling, which have also been obtained in other studies except for a correction in the coefficient, ε₂₂, to compensate for penetration depth of the field in liquid.

Fringing Fields. Fringing fields are generated at the edges of the electrodes of the TSM, much like those formed around capacitors. With the device operating in liquid, these fields interact with ions and dipoles in the liquid thus modifying equivalent circuit parameters and resonance frequencies of the crystal. It should be noted that in spite of the lack of electric fields emanating from a null terminal, fringing fields exist at the electrode edges even at the grounded side of a capacitor. In TSM devices, fringing fields develop lateral potential differences at the vicinity of the electrode edges. These potential differences can be enhanced and utilized by modification of the electrode geometry to uneven sizes.

Electrode edge phenomena in TSM devices have been attributed merely to the fringing fields originating from the excitation potential applied between the two electrodes of the crystal. Accordingly, little importance is attached to acoustoelectric phenomena and Δƒₚ and the energy dissipation factor of the crystal are simply related to the conductivity of the liquid. The proposed equivalent circuit has a static arm that is virtually identical to what was proposed previously. In terms of practical importance, there is not much difference between the two models. Both models entail the penetration of electric fields into the conducting liquid at the vicinity of the electrode edges.

Stray Capacitances. Stray capacitances form between the crystal electrodes and surrounding conductors. This effect can result in erroneous device responses, if not taken into careful account. It is noteworthy to mention that a significant increase in frequency shift was observed previously for conductive and dielectric loading, when the cell was isolated from its environment by a grounded copper coil. This implies that stray capacitance may indeed affect device response. Given the additional observation that the magnitude of a capacitor in series with the device can even reverse device response, it is necessary to consider the formation and/or change of any capacitance around the oscillating crystal. Although the studies quoted above have used a whole crystal-in solution configuration, it is expected that stray capacitance will occur around devices operating with one side in contact with solution.

Electrical Double Layer. The potential drop across and the charge accumulation at the interface are best described by the capacitance of the double layer (C_{dl}). This capacitance is considered as the serial combination of the capacitances of the constituent layers: the inner Helmholz layer (C_{IHP}), the outer Helmholz layer (C_{OHP}), and the diffuse layer (C_{dif}):

$$\frac{1}{{C}_{dl}} = \frac{1}{{C}_{IHP}} + \frac{1}{{C}_{OHP}} + \frac{1}{{C}_{dif}} \qquad ( 6 )$$

There is a plane in the diffuse layer where the ions can be removed from thee surface by lateral motion of the solution. This plane is called the electrokinetic slip plane (distinguished from the viscous slip plane) and is associated with a practically important potential known as the ζ (Zeta) potential. The sharpness of the slip plane is just an, assumption and its location can be at any point beyond the HOP depending on the speed of the moving liquid and characteristics of the double layer.

### SUMMARY OF THE INVENTION

According to the invention there is provided a modified TSM electrode comprising a crystal, and an electrode contacting the crystal, the electrode having an enhanced edge region. Further, the invention provides a method of enhancing acoustic wave sensor response in a TSM electrode comprising the step of modifying the electrode to include an enhanced edge region. The enhanced edge region of the electrode may comprise, for example, an increased perimeter distance or etching within the perimeter of the electrode. The increased perimeter may optionally comprise an irregularly shaped edge.

### DESCRIPTION OF THE DRAWINGS

FIG. 1. Effect of the polarity of the TSM crystal electrode on device response at different electrolyte concentrations: data points are responses from [symbol] grounded and ▪ active electrode facing to the solution; a) and b): changes in series resonance frequency Δ′ƒₛ; c) changes in parallel resonance frequency Δƒₚ; d) changes in static capacitance parameter of the equivalent circuit of the device ΔC₀.

FIG. 2. Effect of modification of electrode on TSM device response versus electrolyte concentration. Part I extending the electrode to cover one side of the crystal completely: a) top and side view of crystals with configuration ƒ for coated side facing to the solution, b for coated side to N₂, n for unmodified crystal; data points [symbol] , ▪, and ♦ represent ƒ, b, and n configurations, respectively; b) and c) change of series resonance frequency; d) change of parallel resonance frequency.

FIG. 3. More data on configurations of FIG. 2: a) change of series resonance frequency Δƒₛ with electrolyte concentration when the electrode to the solution is (+) active, or (−) grounded; b) and c) change of motional resistance parameter of equivalent circuit of the device ΔRₘ versus electrolyte concentration; d) interdependence of ΔRₘ and Δƒₛ.

FIG. 4. Effect of modification of electrode on TSM device response versus electrolyte concentration. Part II removal of spots from the electrode: a) top view of crystals with configuration u for unmodified, c for spot removed from center, e for spot removed from out of center; data points [symbol] , ▪, and ♦ represent c, e, and u configurations, respectively; b) and c) change of series resonance frequency Δƒₛ; d) change of parallel resonance frequency Δƒₚ.

FIG. 5. Effect of modification of electrode on TSM device response versus electrolyte concentration. Part III removal of radial lines from the electrode: a) top view of crystal with modified electrode; data points ▪ and ♦ represent the modified and unmodified configurations, respectively; b) and c) change of series resonance frequency Δƒₛ; d) change of parallel resonance frequency Δƒₚ.

FIG. 6. Traces of changes of a) series resonance frequency Δƒₛ and b) motional resistance parameter of the equivalent circuit of the device ΔRₘ for introduction of the specified reagents to ♦ unmodified and ▪ type III modified electrode.

FIG. 7. Traces of changes of the series resonance frequency Δƒₛ for introduction of ♦ avidin (Av) and ▪ neutravidin (NAv) followed by biotin-labeled insulin (BI) with intermittent buffer washings.

### DETAILED DESCRIPTION

The invention relates to a TSM electrode comprising a crystal, and an electrode contacting the crystal, the electrode having an enhanced edge region. Further, the invention relates to a method of enhancing acoustic wave sensor response in a TSM electrode comprising the step of modifying the electrode to include an enhanced edge region.

The enhanced edge region may comprise an increased perimeter distance or etching within the perimeter of the electrode. Further, the increased perimeter distance may be accomplished by having an irregularly shaped edge on the electrode, for example, having a non-circular edge, which may have regular protrusions or indentations therein. The protrusions or indentations may be angular or smooth at the edges thereof. Any electrode shape that increases the perimeter beyond that of the perimeter defined by a circle may be used to enhance the electrode.

The effect of the geometry, polarity of the exciting electrodes, and stray capacitance on the performance of the thickness-shear mode acoustic wave sensor operating in electrolytes and solutions of biomolecules has been studied. In contrast to the well-known mass-based response of the device operating in the gas phase, the response in a liquid is governed by several factors including acoustoelectric, and fringing field effects, which are known to be active at the edges of the electrodes. In order to investigate and utilize these effects, we modified the electrode geometry to increase the edge length, which, in turn, raises the sensitivity of the device. This modification, which constituted either complete coverage of the back of the device with electrode material or the removal of disks and lines from the electrode surface, resulted in a two to three times enhancement of sensor response. Such modifications, that extend device sensitivity beyond the electrode area to the quartz region of the sensing structure also provide a better surface for the immobilization of various probes. We verified the enhancing ability of the modified electrodes for the case of adsorption of the protein avidin and neutravidin, followed by their affinity reactions with biotinylated biomolecules. It was found that the active electrode in contact with electrolyte exhibits a sensitivity of about twice as that of the grounded electrode. The existence of stray, capacitance around the cell was confirmed by shielding the cell assembly with a bath of concentrated KCl solution. This shielding effect was measured to be about 25-60 Hz in series resonant frequency and −1000 Hz in parallel resonant frequency.

Experimental

Materials and Reagents. All reagents were freshly prepared from the specified commercial products without further treatment. Electrolyte solutions were prepared in specified concentrations using analytical grade salts purchased from Sigma-Aldrich Canada. Protein solutions were made with a concentration of 1 mg/mL in buffer solution unless otherwise stated. The buffer solution (b) had a pH of 7.5 and was comprised of 10 mM Tris-HCl (GibcoBRL 15567-019), 70 mM NaCl (Sigma S-5150), and 0.2 mM EDTA (Sigma E-7889). Biotin-labeled dextran with MW of 70,000 (BD7) (Sigma B-5512); biotin-labeled bovine albumin 95% pure (BBA) (Sigma A-8549); biotin-labeled insulin 50% pure (BI) (Sigma I-2258); avidin from egg white (Av) (Sigma A-9390/A-9275) were purchased from Sigma-Aldrich Canada. ImmunoPure neutravidin (NAv) (Pierce No. 31000) was purchased from Pierce Chemical Inc. Quartz crystals (9 MHz) were obtained from International Crystal Manufacturers Inc. with electrodes of 5 mm diameter and 1000 Å thickness from evaporated gold on a 50-60 Å chromium base with surface roughness of 20 nm. Crystals were used either as received or were cleaned with distilled water, acetone, and a nitrogen stream; some crystals were plasma-treated in nitrogen for 15 min when required. Devices with extended electrodes were prepared by vapor deposition of gold to a thickness of 1000 Å to cover one side completely (except for one mm at the edge that would be covered by an O-ring in the assembly). To prepare the sensors with disks and lines removed from the electrode, use etching chemicals and needles were not successful due to the hard chromium layer underlying the gold coating. However, machine tools with diamond tips were able to perform the task, although a thin layer of the quartz itself was also removed.

Equipment. TSM devices were mounted in an FIA-type cell with one side in contact with solution, which was flowing by means of a peristaltic pump (Eppendorf EVA-pump). The experiments were run at room temperature. The generation and application of an alternating voltage with a frequency of around 9 MHz and the measurement of the reflected impedance were performed with a Network Analyzer (Hewlett Packard 4195A), and the data for measured parameters were transferred to a PC via an IEEE-488 interface (National Instruments GPIB PCIIA).

Procedures. The flow rate of solutions through the cell was 0.1 mL/min. Electrolytes were fed into the cell until constant responses were reached. The cell was thoroughly washed with deionized water before feeding a new electrolyte except for those with successively increasing concentration of ions. To avoid unnecessary consumption of biological reagents, usually 500 μL of reagents were passed through the cell, followed by stopping of flow for a period of time to allow the frequency to stabilize. In most cases, the buffer solution was run through the flow cell to effectively remove excess reagent from the previous injection. To save time in some experiments with electrolytes, we avoided the washing step by starting with the least concentrated solution and evacuated the cell before the introduction of the next more concentrated solution. The network analyzer recorded the admittance and phase data associated with 401 frequency data points centered at the resonance frequency and calculated the values for the elements of equivalent circuit internally. A program written with Lab Windows from National Instruments extracted the data for desired frequencies (such as ƒₛ and ƒₚ, the frequencies at zero phase angle) together with equivalent circuit parameters which were then processed in Microsoft Excel to produce the necessary plots. The precision of the measured frequency was better than 1 Hz, and that for the motional resistance Rₘ was ˜±1 Ω.

Results and Discussion

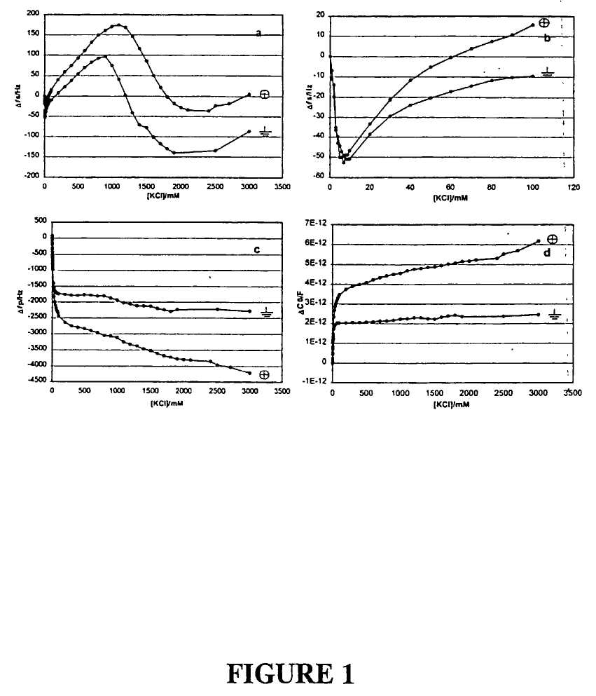

Electrode Polarity and Stray Capacitance. It is a normal practice to ground the electrode of a typical acoustic wave sensor that faces the solution in the cell compartment. The purpose of this design is to minimize interaction of the electrode excitation potential with the adjacent solution Experiments were conducted to measure the response of the device to a range of electrolyte solutions of varying concentration for the switched polarity of the electrodes. FIG. 1, in overall terms, illustrates this comparison and shows that grounding of the electrode in contact with solution reduces, but does not eliminate, electrical effects with respect to the non-grounded configuration. The sole difference between the two arrangements is the electrode polarity; therefore, no other effects such as mass, viscosity, density, conductivity or dielectric constant of the bulk solution can explain the observed discrepancy.

FIGS. 1a and 1b show Δƒₛ values versus concentration of KCl at two different ranges for the normal setup, that is, when the electrode in contact with the solution is grounded, and the alternative arrangement where the electrode is active. The overall shapes of the two profiles both display an interesting periodicity. Briefly, this effect is attributed to periodic changes in the penetration depth of the electric field into solution, which is caused by alterations in the structure, thickness and density of the charged layer at the electrode surface. The two profiles are the same except for their magnitudes, where the curve for active polarity of the electrode exhibits a more positive Δƒₛ and a right shift in its maximum with respect to that of the grounded electrode. The consequence of the latter effect is that the rate of frequency change for the two configurations may be different even opposite for a particular event. For example an increase in electrolyte concentration in the range between the maxima of the two profiles would increase the frequency for active polarity and decrease the frequency for the null polarity case.

FIGS. 1c and 1d also illustrate the effect of reversal of the polarity of the electrodes on the responses of two other parameters involved in operation of TSM devices, namely, changes in the parallel resonance frequency and the static capacitance, C₀. As can be seen, Δƒₚ and ΔC₀ pursue completely different response profiles compared to Δƒₛ with respect to electrolyte concentration. These parameters are also enhanced about two times for the activated electrode compared to the grounded version.

In order to investigate the extent of the effect of alteration of stray capacitances on device response, the cell assembly containing a solution of 1.0 M KCl was shielded by immersion in concentrated KCl. Table 1 summarizes the frequency changes for this experiment and those resulting from shielding the cell with water and with 2.0 M KCl solution. Clearly, water also can shield the cell, which is indicative of the presence of stray capacitances around the device. For an actively polarized electrode in contact with the cell solution, both shielding materials show enhancements compared to the grounded electrode, in accordance with the effect discussed above.

TABLE 1
Effect of shielding of the cell assembly on responses
of the TSM device

| Shielding | Polarity of Electrode | Δfₛ/Hz | Δfₚ/Hz | ΔC₀/pF |
|---|---|---|---|---|
| Solution | Facing to Cell Solution | (±5) | (±100) | (±0.2) |
| Water | Grounded | +25 | −600 | 0.6 |
| 2.0 M KCl | Grounded | +20 | −300 | 0.4 |
| Water | Active | +45 | −1300 | 2.0 |
| 2.0 M KCl | Active | +60 | −1000 | 1.8 |

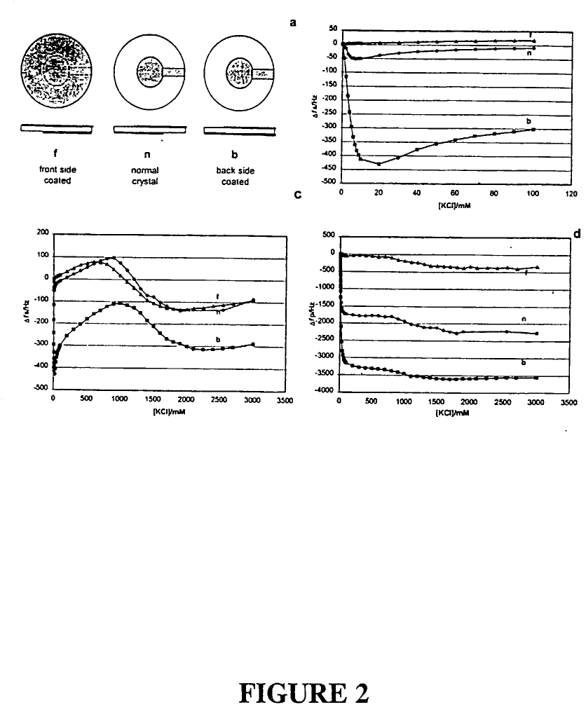

Electrode Modification. In order to examine the effect of modified electrode geometry on the response of the TSM to electrolyte solutions, one side of the device was completely covered with gold with gold by the vapor deposition technique. This arrangement should eliminate the acoustoelectric effect from device behavior for the case where the coated side is set to face the solution in the cell. FIG. 2a depicts the top and the side views of the three geometric configurations of the TSM sensor. Configuration n represent the unmodified crystal; configuration ƒ represents the modified device with the coating on the front (i.e. facing the solution), and b represents the modified structure with the coating on the back (i.e. facing the air). In all three cases the solution-side electrode was grounded. As shown in FIG. 2b, at low concentrations of the electrolyte, Δƒₛ for the f configuration has completely disappeared in comparison with the normal electrode arrangement, whereas structure b exhibits an approximate ten-fold increase. This result strongly supports the notion that electrode edge phenomena, such as the acoustoelectric effect discussed above, play a major role in frequency changes of TSM devices at relatively low electrolyte concentrations. The reason for this lies in the fact that in the ƒ configuration the solution is completely isolated from the active field by a grounded electrode that yields no change a Δƒₛ. It was also found that at low concentrations of electrolyte, switching of electrode polarity does not appreciably affect the frequency response for any of the electrode configurations (not shown).

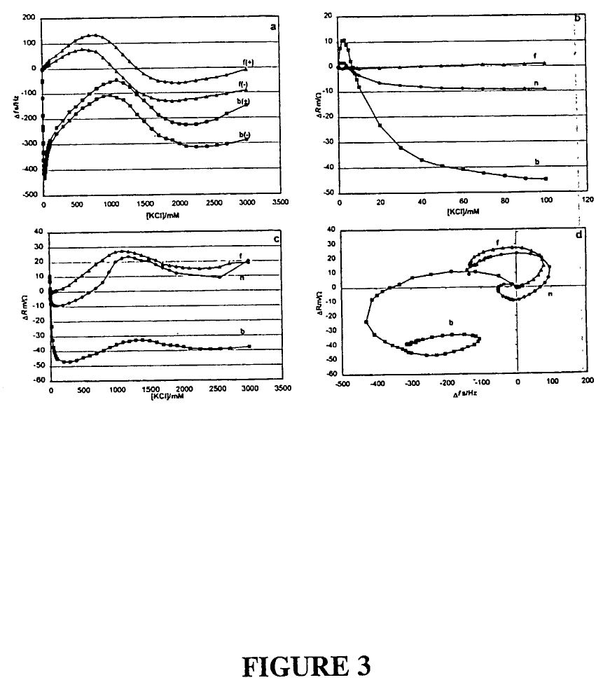

At electrolyte concentrations higher than about 20 mM, as depicted in FIGS. 2c and 2d, the general shapes of the Δƒₛ and Δƒₚ profiles for the three configurations are more or less the same indicating that frequency changes in this region are not affected by acoustoelectric or fringing field processes. FIG. 3a indicates, at higher electrolyte concentrations, that electrically active electrodes produce a positive value for Δƒₛ, compared to the grounded electrode case. Energy dissipation of the device represented by the Rₘ is also highly dependent on electrode configuration at low electrolyte concentrations (FIG. 3b). In contrast, similar profiles are found at high concentrations much as found for changes in resonance frequency. FIGS. 3a and 3c show that the periodicity of the dependence of Δƒₛ, and to some extent ΔRₘ, on electrolyte concentration is preserved for all electrode configurations. This periodicity is better visualized in FIG. 3d, which shows plots of ΔRₘ versus Δƒₛ. In the latter curve, the starting point of the helices is the origin of the coordinates, and as the concentration increases in a logarithmic fashion, the data points trace the helices in an anti-clockwise fashion.

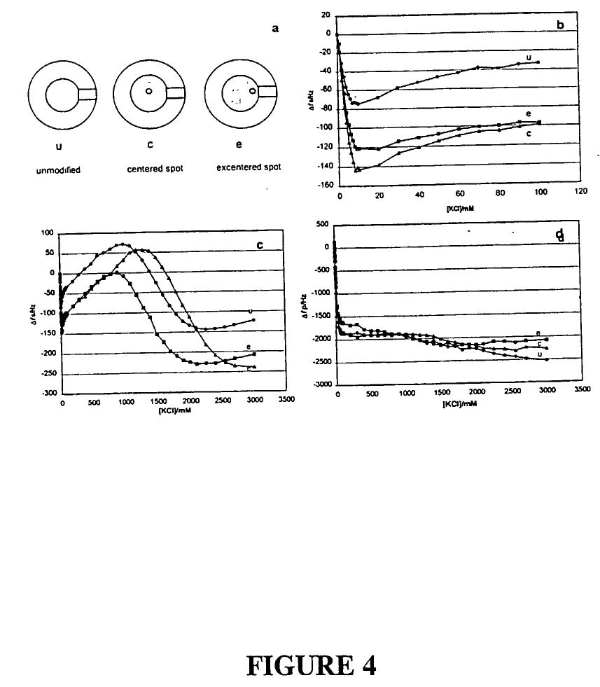

To further investigate the effect of modification of the electrode geometry on sensitivity of the device, disks of 1.5-mm diameter were removed from different locations of the electrode facing to the solution (FIG. 4a). The electrode was also grounded to eliminate the effect of any field emanating from the electrode other than edge fields. This modification is expected to result in the following:

1) Removal of segments of the electrode will increase edge length, in turn raising the intensity of edge fields, which will enhance the sensitivity of the device.

2) If the fringing field is a major contributor to the edge field, then for a given diameter of removed electrode material, the sensitivity of the response will be independent of the location of the disk.

3) If the acoustoelectric effect is a major contributor to the edge field, removal of a disk from the center of electrode will increase the sensitivity of the device compared to the case where it is taken from the outer location. This is because to the fact that the mass sensitivity and device motion, thus the acoustoelectric effect, are greater at the center than at the outside position.

FIGS. 4b and 4c indicate that conditions 1) and 3) are fulfilled. The removal of disks from both positions causes an enhancement of ƒₛ sensitivity with respect to the unmodified crystal, and electrode removal from the center shows a much larger Δƒₛ effect than that for the eccentric location. However, FIG. 4d, shows an almost identical response in ƒₚ for the three configurations. In this connection, it is believed that fringing fields mostly affect the parallel resonance frequency of the device. The insensitivity of ƒₚ toward such a modification of the electrode, as opposed to the considerable enhancement of ƒₛ sensitivity, suggests that acoustoelectric rather than the fringing field plays a major role in operation of the TSM device in electrolyte.

As discussed above, the acoustoelectric effect occurs at moving non-electroded regions of the sensor and is typically instigated at the electrode edges, with rapid decay being manifested over distance. This concept, supported by the results evident in FIG. 4, prompted the design of new electrode configurations with larger edge densities to further increase the sensitivity of the TSM device. Accordingly, radial lines were etched on the electrode of a regular polished TSM sensor with a diamond pen. This process was not limited to the metal coatings in that a component of piezoelectric material was also removed. Confirmation of the magnitude of such mass removal was estimated from Sauerbrey equation for operation of the device in air. The value of Δƒₛ for the etching of lines was about +11.800 kHz, which is clearly several times greater than any mass removed from the chromium-gold layers.

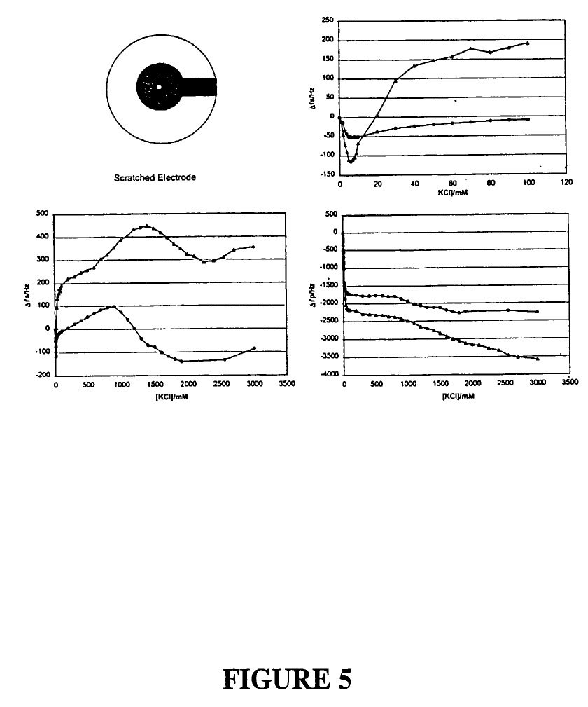

FIG. 5 illustrates a schematic diagram of such a modified crystal together with the resulting Δƒₛ and Δƒₚ profiles for different electrolyte concentrations. A sensitivity enhancement of 2-3 times is achieved in Δƒₛ for both concentration ranges; however, as FIG. 5d shows, Δƒₚ was improved by only ˜25%. The low sensitivity of Δƒₚ to increases in edge density further supports the fact that the acoustoelectric effect is a major factor in the in the operation of the TSM device in electrolyte. It is believed that ƒₚ is related to the electrical resonance of the oscillating circuit as opposed to ƒₛ, which depends on mechanical oscillation of the device. It has also been shown that ƒₚ has a close relationship with C₀, the static capacitance of the equivalent circuit of the device. This means that the ƒₚ is expected to exhibit sensitivity to fringing fields resulting from the increased edge density of the electrode. The results depicted in FIGS. 5b-d indicate that fringing fields play a lesser role in the operation of the TSM device in electrolyte The results of FIGS. 5b-d also provide a tool to distinguish between the effects of these two electric phenomena.

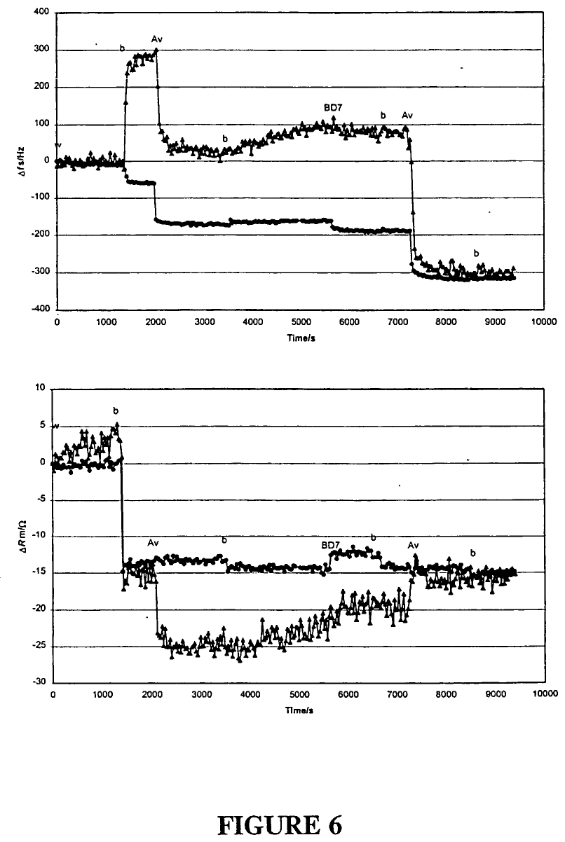

Modified Device Response to Protein Solutions. The effect of electrode modification on the sensitivity of the device towards solutions of proteins often employed in the immobilization of nucleic acids and the like was studied using the line-etched sensor described above. FIG. 6 provides a comparison of time-based plots resulting from modified and unchanged electrodes for the introduction of various reagents in the flow-injection mode. There are several features in this figure that merit discussion. For the modified-electrode case, the noise level is greater and the resolution of the curve is lower compared to that originating from the unmodified electrode. This is understandable since reducing the size of one of the electrodes causes instability in device resonance. Clearly, a tradeoff between stability and sensitivity of the device is involved requiring optimization of any future design. Second, introduction of Tris buffer solution following that of water produces two radically different Δƒₛ responses for the two electrodes, which is essentially in accordance with the observations of FIG. 5b.

It should be mentioned that both profiles were recorded with active electrodes, which means that sensitivity is achieved from polarity considerations in addition to that obtained from electrode modification. Third, Δƒₛ for the introduction of avidin is 2.5 times larger for the modified electrode compared to that for the unmodified case. This corresponds to the same effect observed for electrolytes in FIG. 5. The latter result provides an analogy between the two findings and leads to the conclusion that the protein behaves in the same fashion as electrolyte. This is not unusual, since, avidin is a large globular protein with several positive charges at the pH of the buffer employed in the experiment. The lack of a similar ratio between the two Δƒₛ′ values for the introduction of non-ionic the BD7 macromolecule further supports this conclusion.

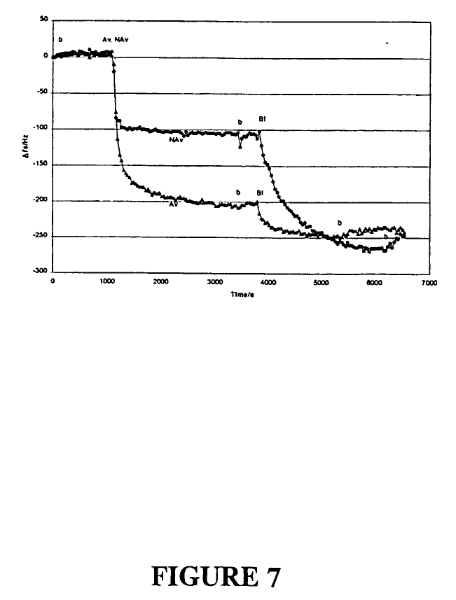

Finally, it is interesting to note that the start and end points off the two profiles overlay despite the radically different underlying electrodes. This means that for the third layer, the excess electric field penetrating into the adjacent electrolyte solution has been completely shielded with the result that the two outer surfaces have become electrically identical. A similar effect is seen in the example illustrated in FIG. 7, where following the introduction of buffer solution neutravidin is added into the cell incorporating an unmodified electrode. Neutravidin is an aglycosylated version of the parent molecule and is almost neutral at the pH used in our experiments. As is evident, neutravidin generates more than twice the frequency drop as that observed for avidin. However, subsequent introduction of biotinylated insulin, which binds to both types of protein, results in considerably different profiles with a much larger decrease occurring for avidin, although at the conclusion of the experiments the overall reduction in frequency is about the same.. This type of additivity in response is also seen in the ΔRₘ plot of FIG. 6b. In this experiment, the values of ΔRₘ for the introduction of the first and second layers of avidin to the modified crystal differ in magnitude and sign.

Conclusions

We have studied the effect of the polarity and geometry of electrodes on the performance of acoustic wave TSM sensors in contact with electrolytes. Active electrode polarity in contact with solution exhibits more sensitivity to the electrolyte loading as opposed to the grounded electrode with the overall profiles being similar for both cases. The existence of stray capacitances around the device, which can affect the its response, was confirmed by shielding the cell assembly with water and with electrolytes. The shielding effect was measured to be about 25-60 Hz in series resonance frequency Δƒₛ, and −1000 Hz in parallel resonance frequency Δƒₚ. Modified electrode geometry to study the sensitivity of the device and origin of the responses when the device is operating in an electrolyte. This was done either by completely covering of the one side of the crystal with electrode or by removing spots and lines from the electrode. The results proved an enhancement 2-3 times in device response. This enhancement was tested and confirmed on a modified electrode with radial lines removed from the surface. The major contributor to device response was found to be the acoustoelectric effect rather than the fringing field effect. It was also found that the former affects the ƒₛ more and the latter modifies the ƒₚ. This finding provides a tool to discriminate the responses from the two effects. In other words, it is possible to monitor the acoustoelectric and the fringing field effects through resonance frequencies Δƒₛ and Δƒₚ of the TSM device using a network analyzer.

### EXAMPLE

### Electrode Enhancement

The invention allows enhancement of the sensor signal through intensification of electric fields in different ways, as described herein. For example, the electrode can be modified by assigning the active terminal of the alternating applied potential to the electrode in contact with solution in lieu of the null terminal that is usually assigned. Further, by increasing the uncompensated charges at the device surface by extending the back electrode, the signal may be modified. Additionally, by increasing the length of the electrode edges by removing lines and patterns from the electrode surface so that the underlying quartz crystal is exposed, the electrode response is modified.

Electrodes modified according to methods described herein were tested using simple electrolytes. A signal enhancement of several times was observed for each of the electrodes. A combination of methods further enhanced the signals to the extent that at high electrolyte concentrations, the device ceased to operate. The enhancement was prominent for electrodes modified with method of increasing the length of the electrode edges by removing lines and patterns from the electrode surface to expose the crystal. However, the level of noise started to increase beyond a certain “line density” on the electrode surface, which is in agreement with the requirements for the oscillation of quartz crystal.

The signal enhancement was confirmed by testing with a real biological sample. Protein Neutravidin was adsorbed as a probe on a sensor having an electrode modified by increasing the length of the electrode edges by removing lines and patterns from the electrode surface. Another protein (insulin) labeled with a small molecule (biotin) having a high affinity to Neutravidin, was introduced to the operating sensor. The bio-reaction was detected with a signal, which was 2.5 times larger than that of the unmodified electrode.

It should be noted that higher enhancements are achievable for more optimized pattern designs and method combinations. The best signal enhancements were achieved at different ranges of electrolyte concentrations for the combined three methods of: increasing length of electrode edges, assigning the active terminal to the electrode in contact with solution, and increasing the uncompensated charges at the device surface by extending the back electrode. This provides flexibility with respect to signal enhancement method to suit a designated usage and meet specific experimental requirements.

1. A TSM electrode comprising a crystal, and an electrode contacting the crystal, the electrode having an enhanced edge region comprising an electrode modification selected from the group consisting of an increased perimeter distance and etching within the perimeter of the electrode.

2. The electrode of claim 1 wherein said increased perimeter distance comprises an irregularly shaped edge.

3. A method of enhancing acoustic wave sensor response in a TSM electrode comprising the step of modifying the electrode to include an enhanced edge region by either increasing perimeter distance or etching within the perimeter of the electrode.

4. The method of claim 3, wherein said step of modifying the electrode comprises forming an irregularly shaped edge at the perimeter of the electrode.
